(19) United States
(12) Patent Application Publication
(10) Pub. No.: US 2018/0143601 A1
(43) Pub. Date: May 24, 2018

(54) BUILDING MANAGEMENT SYSTEM WITH OCCUPANCY TRACKING USING WIRELESS COMMUNICATION

(71) Applicant: Johnson Controls Technology Company, Milwaukee, WI (US)

(72) Inventors: Avinash Chavan, Navi Mumbai (IN); Abhai Dhatavkar, Mumbai (IN); Ashok Sridharan, TIRUCHIRAPPALLI (IN)

(73) Assignee: Johnson Controls Technology Company, Milwaukee, WI (US)

(21) Appl. No.: 15/812,260

(22) Filed: Nov. 14, 2017

Related U.S. Application Data
(60) Provisional application No. 62/424,279, filed on Nov. 18, 2016.

(51) Int. Cl. G05B 19/048; F24F 11/00

(52) U.S. Cl. CPC G05B 19/048; F24F 11/0012; F24F 11/0034; F24F 11/006; F24F 11/0086; F24F 2011/0035; G05B 2219/2614; F24F 2011/005; F24F 2011/0064; F24F 2011/0068; F24F 2011/0091; G05B 2219/2642; F24F 2011/0036

(57) ABSTRACT

An occupancy tracking system for tracking occupancy within a building is configured to determine one or more wireless signal strengths for one or more wireless connections between one or more wireless routers and one or more user devices located within the building. The system is configured to determine, based on the one or more wireless signal strengths, the locations of one or more occupants associated with the user devices within the building and the number of the one or more occupants located within the building and control one or more pieces of building equipment based on the locations of the one or more occupants and the number of the one or more occupants.

### CROSS-REFERENCE TO RELATED PATENT APPLICATION

This application claims the benefit of and priority to U.S. Provisional Patent Application No. 62/424,279 filed Nov. 18, 2016, the entire disclosure of which is incorporated by reference herein.

### BACKGROUND

The present disclosure relates generally to a building management system (BMS) for monitoring and controlling conditions within a building or building space. The present disclosure relates more particularly to a BMS and occupancy tracking. Conventional occupancy in a building is determined through infrared sensing, digital audio processing, and/or digital video processing. However, such techniques can be inaccurate and difficult to implement. It would be desirable to track building occupancy in a manner that overcomes the disadvantages associated with conventional occupancy tracking techniques.

### SUMMARY

One implementation of the present disclosure is an occupancy tracking system for tracking occupancy within a building, the occupancy tracking system configured to determine one or more signal strengths between one or more routers and one or more user devices located within the building. The occupancy tracking system is further configured to determine, based on the one or more signal strengths, the locations of one or more occupants associated with the user devices within the building and the number of the one or more occupants located within the building. The occupancy tracking system is further configured to control one or more pieces of building equipment based on the locations of the one or more occupants and the number of the one or more occupants.

In some embodiments, the occupancy tracking system further includes the one or more routers. Each of the one or more routers can be configured to determine one or more signal strengths between the router and the one or more user devices and send the signal strengths to a building management system. In some embodiments, the occupancy tracking system further includes the building management system. The building management system can be configured to receive, from each of the one or more routers, the signal strengths and determine, based on the received signal strengths, the locations and the number of the occupants within the building.

In some embodiments, the occupancy tracking system further includes the one or more user devices. Each of the one or more user devices can be configured to determine the one or more signal strengths between the one or more routers and the user device, determine, based on the received signal strengths, the location of the occupant associated with the user device within the building, and send an indication of the location of the occupant to a building management system.

In some embodiments, the occupancy tracking system is configured to record the determined number of occupants within the building for a plurality of times. In some embodiments, the occupancy tracking system is configured to predict, based on the recorded number of occupants within the building for the plurality of times, a predicted number of occupants within the building for a particular time. In some embodiments, the occupancy tracking system is configured to control, based on the predicted number of occupants, the one or more pieces of building equipment at a time before the particular time to achieve a particular temperature in the building at the particular time.

In some embodiments, the occupancy tracking system is configured to generate an interface for displaying, on a display of one of the one or more user devices, the interface includes an indication of the locations of the one or more occupants associated with the one or more user devices within the building and indications of identities of the occupants associated with the user devices, the identities of the occupants are based on identifiers of the user devices.

In some embodiments, the indication of the locations of the occupants includes heat signatures that indicate the density of occupancy at particular locations within the building.

In some embodiments, the occupancy tracking system is configured to receive environmental configuration settings for one or more zones of the building from the one of the one or more user devices and control the one or more pieces of building equipment based on the locations of the one or more occupants, the number of the one or more occupants, and the received environmental configuration settings.

In some embodiments, the environmental configuration settings include at least one of one or more heating configuration settings, one or more air conditioning configuration settings, one or more airflow configuration settings, and one or more lighting configuration settings.

In some embodiments, the configuration settings include zone configuration information for a zone of the building, the zone configuration information including a maximum occupancy level, a minimum occupancy level, a first temperature offset associated with the maximum occupancy level, and a second temperature offset associated with the minimum occupancy level. In some embodiments, the occupancy tracking system is configured to determine a plurality of third temperature offsets based on the maximum occupancy level, the minimum occupancy level, the first temperature offset, and the second temperature offset, each third temperature offset associated with a potential number of occupants within the zone. In some embodiments, the occupancy tracking system is configured to determine, based on the locations of the one or more user devices, an actual number of occupants within the zone of the building and control one or more of the one or more pieces of building equipment that are associated with the zone of the building based on the determined third temperature offsets and the actual number of occupants within the zone of the building.

Another implementation of the present disclosure is a method for tracking occupancy within a building. The method includes determining one or more signal strengths between one or more routers and one or more user devices located within the building. The method further includes determining, based on the one or more signal strengths, the locations of one or more occupants associated with the user devices within the building and the number of the one or more occupants located within the building. The method further includes controlling one or more pieces of building equipment based on the locations of the one or more occupants and the number of the one or more occupants.

In some embodiments, the method further includes, for each of the one or more routers, determining, by the router, one or more signal strengths between the router and the one or more user devices and sending, by the router, the signal strengths to a building management system. In some embodiments, the method further includes receiving, by the building management system, the signal strengths from each of the one or more routers and determining, by the building management system, based on the received signal strengths, the locations and the number of the occupants within the building.

In some embodiments, the method further includes, for each of the one or more user devices, determining the one or more signal strengths between the one or more routers and the user device, determining, based on the received signal strengths, the location of the occupant associated with the user device within the building, and sending an indication of the location of the occupant to a building management system.

In some embodiments, the method further includes recording the determined number of occupants within the building for a plurality of times, predicting, based on the recorded number of occupants within the building for the plurality of times, a predicted number of occupants within the building for a particular time, and controlling, based on the predicted number of occupants, the one or more pieces of building equipment at a time before the particular time to achieve a particular temperature in the building at the particular time.

In some embodiments, the method further includes causing a display of one of the one or more user devices to display an interface, the interface including an indication of the locations of the one or more occupants associated with the one or more user devices within the building and indications of identities of the occupants associated with the user devices, the identities of the occupants are based on identifiers of the user devices.

In some embodiments, the indication of the locations of the occupants includes heat signatures that indicate the density of occupancy at particular locations within the building.

In some embodiments, the method further includes receiving environmental configuration settings for one or more zones of the building from the one of the one or more user devices and controlling the one or more pieces of building equipment based on the locations of the one or more occupants, the number of the one or more occupants, and the received environmental configuration settings.

In some embodiments, the environmental configuration settings include at least one of one or more heating configuration settings, one or more air conditioning configuration settings, one or more airflow configuration settings, and one or more lighting configuration settings.

In some embodiments, the configuration settings include zone configuration information for a zone of the building, the zone configuration information includes a maximum occupancy level, a minimum occupancy level, a first temperature offset associated with the maximum occupancy level, and a second temperature offset associated with the minimum occupancy level. In some embodiments, the method further includes determining a plurality of third temperature offsets based on the maximum occupancy level, the minimum occupancy level, the first temperature offset, and the second temperature offset, each third temperature offset associated with a potential number of occupants within the zone. In some embodiments, the method further includes determining, based on the locations of the one or more user devices, an actual number of occupants within the zone of the building and controlling one or more of the one or more pieces of building equipment that are associated with the zone of the building based on the determined third temperature offsets and the actual number of occupants within the zone of the building.

Another implementation of the present disclosure is an occupancy tracking system for tracking occupancy within a building. The occupancy tracking system is configured to determine one or more signal strengths between one or more routers and one or more user devices located within the building, determine, based on the one or more signal strengths, the locations of one or more occupants associated with the user devices within the building and the number of the one or more occupants located within the building, and generate an interface for display on a display of one of the one or more user devices. The interface includes an indication of the locations of the one or more occupants associated with the one or more user devices within the building, the indication of the locations of the occupants includes heat signatures that indicate the density of occupancy at particular locations within the building and indications of identities of the occupants associated with the user devices, the identities of the occupants are based on identifiers of the user devices. The occupancy tracking system is configured to control one or more pieces of building equipment based on the locations of the one or more occupants and the number of the one or more occupants.

In some embodiments, the occupancy tracking system is configured to receive environmental configuration settings for one or more zones of the building from the one of the one or more user devices and control the one or more pieces of building equipment based on the locations of the one or more occupants, the number of the one or more occupants, and the received environmental configuration settings.

### BRIEF DESCRIPTION OF THE DRAWINGS

FIG. 1 is a drawing of a building equipped with a HVAC system, according to an exemplary embodiment.

FIG. 2 is a block diagram of a waterside system that may be used in conjunction with the building of FIG. 1, according to an exemplary embodiment.

FIG. 3 is a block diagram of an airside system that may be used in conjunction with the building of FIG. 1, according to an exemplary embodiment.

FIG. 4 is a block diagram of a user device connected to three routers located in the building of FIG. 1, the three routers communicating to a building management system and an application server, according to an exemplary embodiment.

FIG. 5 is a block diagram of a user device connected to three routers running custom building management system (BMS) firmware located in the building of FIG. 1, according to an exemplary embodiment.

FIG. 6 is a block diagram of the user device of FIG. 4 in greater detail, according to an exemplary embodiment.

FIG. 7 is a block diagram of the BMS of FIG. 4 in greater detail, according to an exemplary embodiment.

FIG. 8 is a diagram of a building floorplan for a building space that may contain the locations of heat signatures inside the building space determined by the user device and/or the BMS of FIG. 4, according to an exemplary embodiment.

FIGS. 9A and 9B are diagrams of a dashboard for an occupancy detection and data logging system of the application server of FIG. 4 and/or the BMS of FIG. 5, according to exemplary embodiments.

FIG. 10 is a flowchart of a process for updating a floor plan for a building and recording occupancy that can be performed by the application server and/or BMS of FIG. 4, according to an exemplary embodiment.

FIG. 11 is a flowchart of operations for determining the location of a user device that can be performed by the user device of FIG. 4, according to an exemplary embodiment.

FIG. 12 is a flowchart of operations for determining the location of a user device that can be performed by the BMS of FIG. 4, according to an exemplary embodiment.

FIG. 13 is a flowchart of operations for controlling a building space based on detected occupancy that can be performed by the BMS of FIG. 4, according to an exemplary embodiment.

FIG. 14 is a diagram of a live value screen for the application server and/or the BMS of FIG. 4 that displays occupancy density and logged data, according to exemplary embodiments.

FIGS. 15 and 16 are diagrams of a configuration screen for the application server and/or the BMS of FIG. 4 displaying facility configuration information and logged data, according to exemplary embodiments.

FIGS. 17, and 18 are diagrams of a control strategy screen for the application server and/or the BMS of FIG. 4, according to exemplary embodiments.

FIG. 19 is a diagram of a dashboard for the application server and/or BMS of FIG. 4 for displaying occupancy heat analytics, according to an exemplary embodiment.

FIG. 20 is a diagram of a dashboard for the application server and/or the BMS of FIG. 4 for displaying occupancy tracking data, according to an exemplary embodiment.

FIG. 21 is a diagram of a dashboard for the application server and/or the BMS of FIG. 4 displaying occupancy tracking data, according to an exemplary embodiment.

### DETAILED DESCRIPTION

Referring generally to the FIGURES, a building management system (BMS) with occupancy tracking using wireless fidelity (Wi-Fi) are shown, according to various exemplary embodiment. The systems and methods described herein may be used to determine the occupancy of one or more building spaces within a building based on the signal strengths between user devices and building routers. By communicating with user devices such as smartphones, building occupancy can be determined based on connections to a wireless network. The wireless network may be a Wi-Fi network and may be deployed through a building space via routers.

Based on connections and signal strengths between user devices and routers, an approximate location of each user device in the building space can be determined. In some embodiments, each user device may run an application allowing it to determine its own position based on trilateration between various building routers. In some embodiments, the building routers are configured to gather necessary information from a user device, and transmit the information to a BMS which in turn uses the information to perform a trilateration calculation. A web based application server communicates to the user devices and/or the BMS and allows users to access information regarding the building occupancy through a web based environment. The web based application server in communication with the user device may then be used to adjust the controls of the BMS based on the building occupancy. Further, the BMS may use the occupancy to perform energy efficient control of the building. For example, each zone of a building can be heated and/or conditioned based on that zones occupancy. Further, lighting in each zone can be adjusted based on the identified occupancy. Additional features and advantages of the BMS are described in greater detail below.

### Building Management System and HVAC System

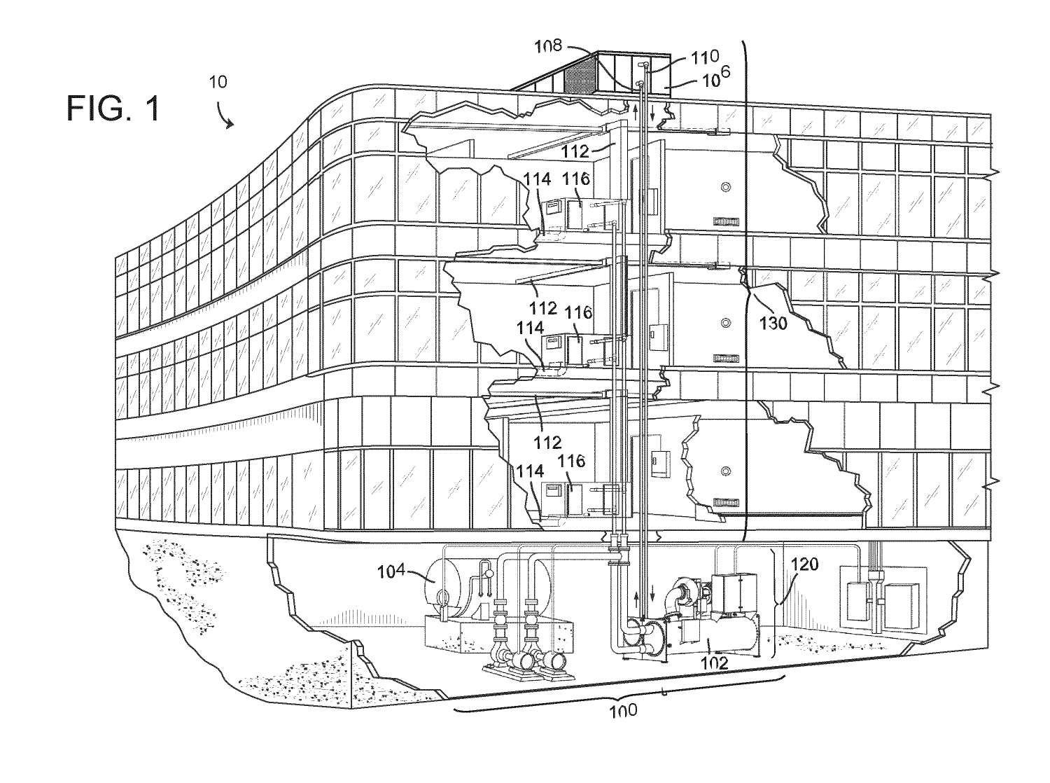

Referring now to FIGS. 1-3, an exemplary building management system (BMS) and HVAC system in which the systems and methods of the present invention can be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

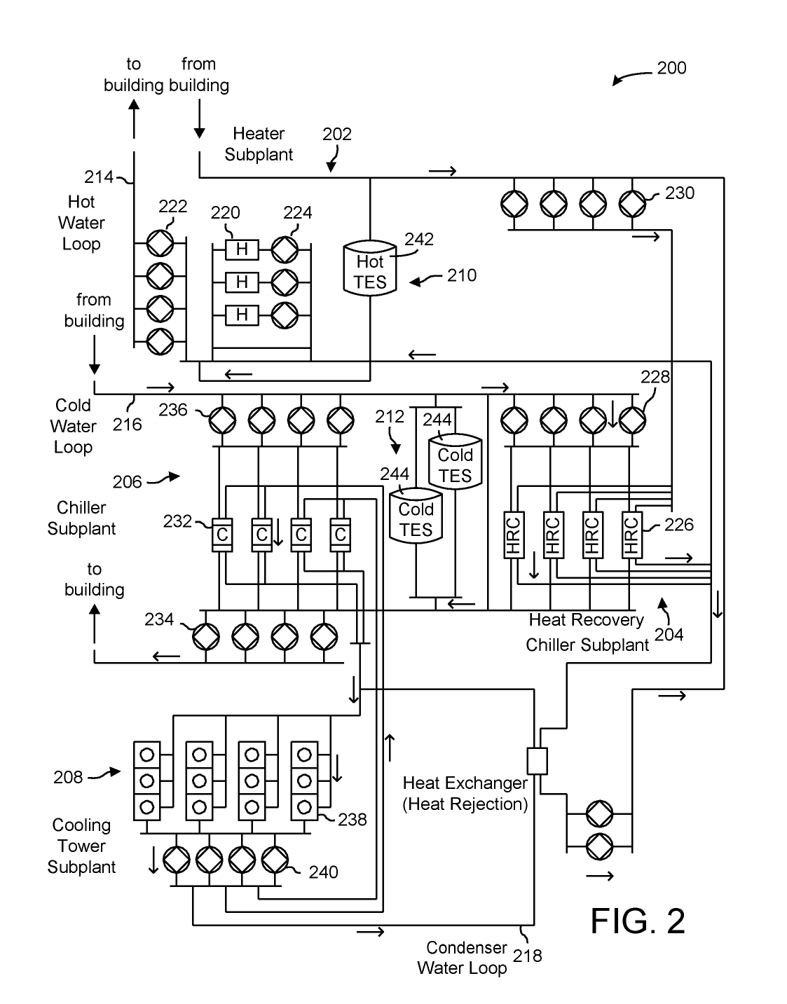

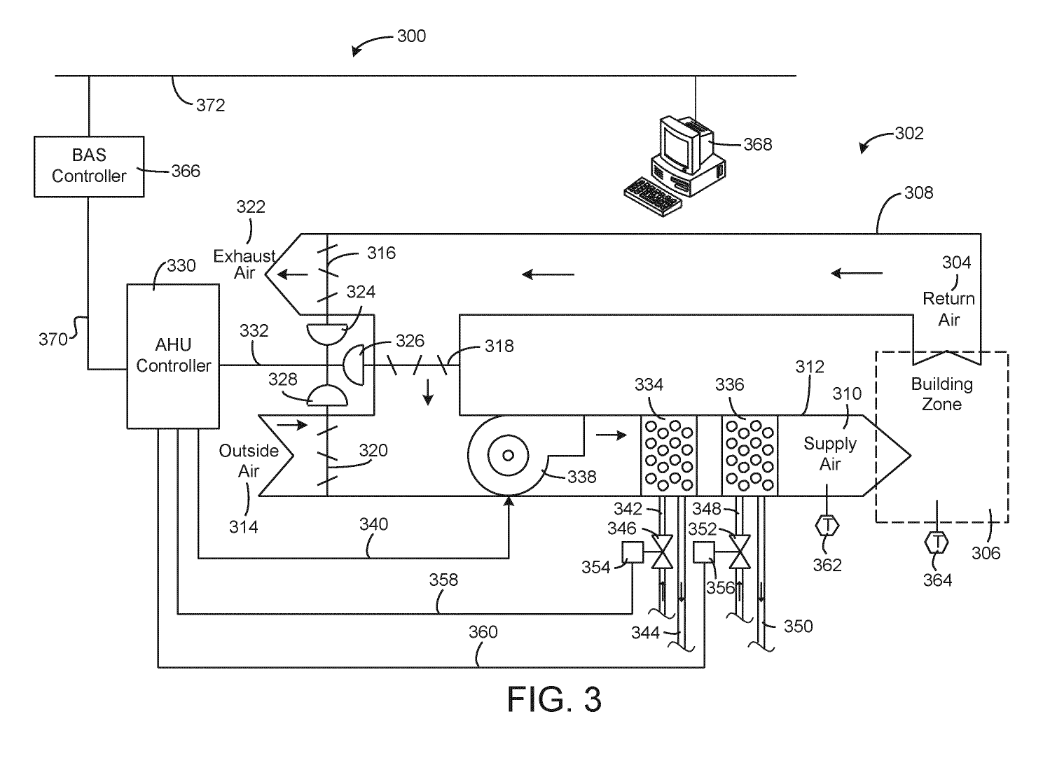

The BMS that serves building 10 includes an HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

Referring now to FIG. 2, a block diagram of a waterside system 200 is shown, according to an exemplary embodiment. In various embodiments, waterside system 200 can supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and can operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 can absorb heat from the cold water in chiller subplant 206 and reject the absorbed heat in cooling tower subplant 208 or transfer the absorbed heat to hot water loop 214. Hot TES subplant 210 and cold TES subplant 212 can store hot and cold thermal energy, respectively, for subsequent use.

Hot water loop 214 and cold water loop 216 can deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve the thermal energy loads. In other embodiments, subplants 202-212 can provide heating and/or cooling directly to the building or campus without requiring an intermediate heat transfer fluid. These and other variations to waterside system 200 are within the teachings of the present invention.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 can also include one or more pumps or valves configured to control the flow rate of the hot water into or out of hot TES tank 242. Cold TES subplant 212 is shown to include cold TES tanks 244 configured to store the cold water for later use. Cold TES subplant 212 can also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

Referring now to FIG. 3, a block diagram of an airside system 300 is shown, according to an exemplary embodiment. In various embodiments, airside system 300 can supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 can operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 can receive return air 304 from building zone 306 via return air duct 308 and can deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 can communicate with an AHU controller 330 via a communications link 332. Actuators 324-328 can receive control signals from AHU controller 330 and can provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 can communicate with fan 338 via communications link 340 to control a flow rate of supply air 310. In some embodiments, AHU controller 330 controls an amount of heating or cooling applied to supply air 310 by modulating a speed of fan 338.

Cooling coil 334 can receive a chilled fluid from waterside system 200 (e.g., from cold water loop 216) via piping 342 and can return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 can receive a heated fluid from waterside system 200(e.g., from hot water loop 214) via piping 348 and can return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 can communicate with AHU controller 330 via communications links 358-360. Actuators 354-356 can receive control signals from AHU controller 330 and can provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 can also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 can control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 can communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 can provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 can communicate with BMS controller 366 and/or AHU controller 330 via communications link 372.

### Occupancy Detection System

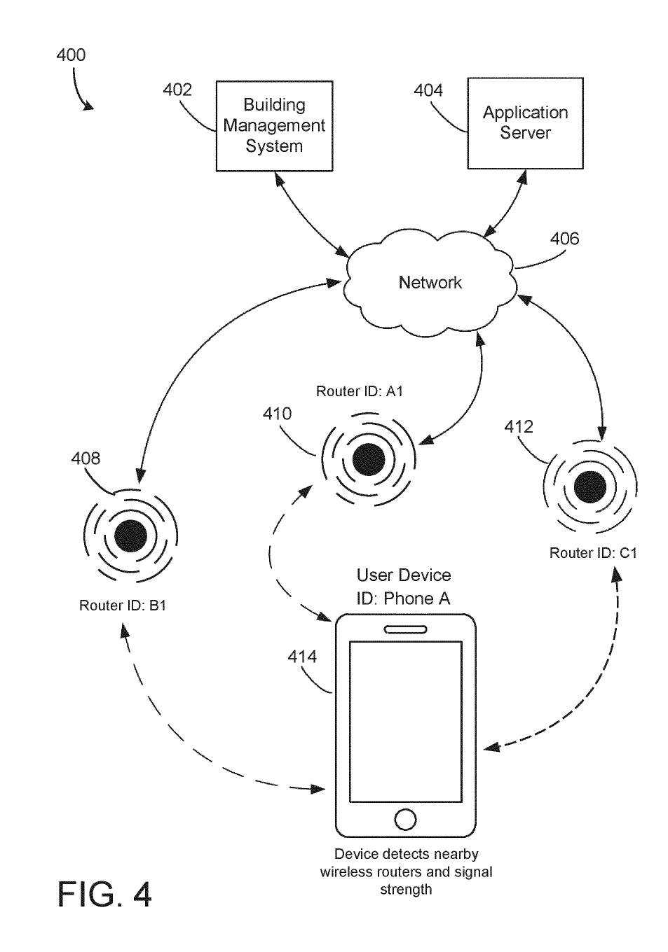

Referring now to FIG. 4, a block diagram of an occupancy tracking system 400 is shown according to an exemplary embodiment. System 400 can be implemented in a building space to determine the occupancy of the building space based on Wi-Fi router connections and signal strengths. System 400 is shown to include building management system 402, application server 404, network 406, routers 408-412, and user device 414. In some embodiments, building management system 402 operates the building space as described in FIGS. 1-3. Building management system 402 is shown to be connected to application server 404 and routers 408-412. In some embodiments, network 406 is at least one of and/or a combination of a Wi-Fi network, a wired Ethernet network, a Zigbee network, and a Bluetooth network. Network 406 may be a local area network or a wide area network (e.g., the Internet, a building WAN, etc.) and may use a variety of communications protocols (e.g., BACnet, IP, LON, etc.).

Application server 404 may be a remote server and may be hosted at a remote location. Application server 404 may be configured to provide a web-based presence for users and/or building administrators to access information regarding occupancy of the building. In some embodiments, application server 404 allows users and/or building administrators to view data pertaining to the number of users in the building space and their respective locations. Application server 404 may communicate with user device 414 through routers 408-412 or may communicate to user device 414 via mobile data (e.g. 1G, 2G, 3G, LTE, etc.).

In some embodiments, application server 404 integrates a building facility web application with the determined number and location of occupants. In some embodiments, the building facility application may control room, zone, building, and campus lighting, conference room booking, public service announcements and other features of a building facility. In some embodiments, the building facility web application may identify a user when a device associated with the user (e.g., user device 414) is detected in a room, zone, building and/or campus based on wireless signal strengths. The building facility web application may automatically login the identified user with the building web facility application. A user that has been logged in may be able to change lighting, environmental setpoints and any other adjustable building facility web application feature via user device 414. In some embodiments, the building facility web application may automatically adjust lighting and environmental setpoints to preferred settings of the identified and logged in user.

Routers 408-412 may be installed for the specific purpose of determining user occupancy or may be existing routers in a wireless building network. In some embodiments, each router may have a unique identifier (ID). In FIG. 4, router 408 has the ID Bl, router 410 has the ID Al, and router 412 has the ID Cl. Routers 408-412 may connect user device 414 to the Internet through network 406. Although only three routers 408-412 are shown in FIG. 4, it is contemplated that system 400 can include any number of routers located in the building space.

Routers 408-412 can be configured to emit, receive, sense, relay, or otherwise engage in unidirectional or bidirectional wireless communications. Routers 408-412 can use any type wireless technology or communications protocol. For example, in various embodiments, the wireless emitters/receivers can be Bluetooth low energy (BLE) emitters, near field communications (NFC) devices, Wi-Fi transceivers, RFID devices, ultrawide band (UWB) devices, infrared emitters/sensors, visible light communications (VLC) devices, ultrasound devices, cellular transceivers, iBeacons, or any other type of hardware configured to facilitate wireless data communications. In some embodiments, routers 408-412 are integrated with various devices within the building (e.g., thermostats, lighting sensors, zone controllers).

Routers 408-412 can broadcast a wireless signal. The wireless signal broadcast by routers 408-412 can include the identifier associated with routers 408-412. For example, routers 408-412 can broadcast a SSID, MAC address, or other identifier which can be used to identify a particular router. In some embodiments, the wireless signal broadcast by routers 408-412 includes multiple emitter identifiers (e.g., a UUID value, a major value, a minor value, etc.). User device 414 can detect the wireless signals emitted by the routers 408-412. User device 414 can be configured to identify the router associated with the wireless signal. In some embodiments, user device 414 detects the signal strength of the wireless signals for each of routers 408-412.

In FIG. 4 user device 414 communicates with routers 408-412. User device 414 may communicate to the routers via Wi-Fi, Zigbee, Bluetooth, and/or any other wireless communication protocol. User device 414 may communicate to routers 408-412 and determine a signal strength of each router. In some embodiments, received signal strength (RSSI) is determined by user device 414 for connections to each of routers 408-412. In some embodiments, user device 414 detects the RSSI of the wireless signals received from each of routers 408-412 without engaging in bidirectional communications with any of routers 408-412. For example, user device 414 can passively detect or measure RSSI without actively sending any return data to routers 408-412. In various embodiments, user device 414 determines RSSI as a percentage, in mW, in dBm, and/or in any other unit or power ratio.

User device 414 may store the location of each router 408-412 in a memory device and may determine (e.g., triangulate, estimate, etc.) the location of user device 414 based on the stored locations of routers 408-412 and the determined RSSI value for each router. In some embodiments, user device 414 is only connected to a single router or only receives a wireless signal from a single router. User device 414 may determine an approximate circular field around the single router in which user device 414 may be located based on the determined RSSI. In some embodiments, the circular field is an approximate radius such as a distance that user device 414 may be located away from the router. For example, a strong RSSI may indicate that user device 414 is close to a particular router, whereas a weaker RSSI may indicate that user device 414 is further from the router. User device 414 can use a mapping table or function to translate RSSI into distance. In some embodiments, the translation between RSSI and distance is a function of the router's broadcast power or other router settings, which user device 414 can receive from each router within broadcast range. In some embodiments, the field is a range of radii. Each radii may be different and user device 414 may be located between the two radii in a disc shaped field.

Still referring to FIG. 4, user device 414 may communicate with building management system 402 and/or application server 404 via the routers 408-412. In some embodiments, user device 414 sends is location within the building space to building management system 402 and/or application server 404. In some embodiments, user device 414 sends a unique ID to building management system 402 and/or application server 404. In FIG. 4, the unique ID of user device 414 is Phone A. In some embodiments, building management system 402 is configured to run a unique heating or cooling schedule based on the ID of the user device 414. For example, an environmental setpoint may be tied to the ID of user device 414. Building management system 402 may be configured to adjust the setpoint of the zone in which user device 414 is located to the environmental setpoint tied to the ID of user device 414.

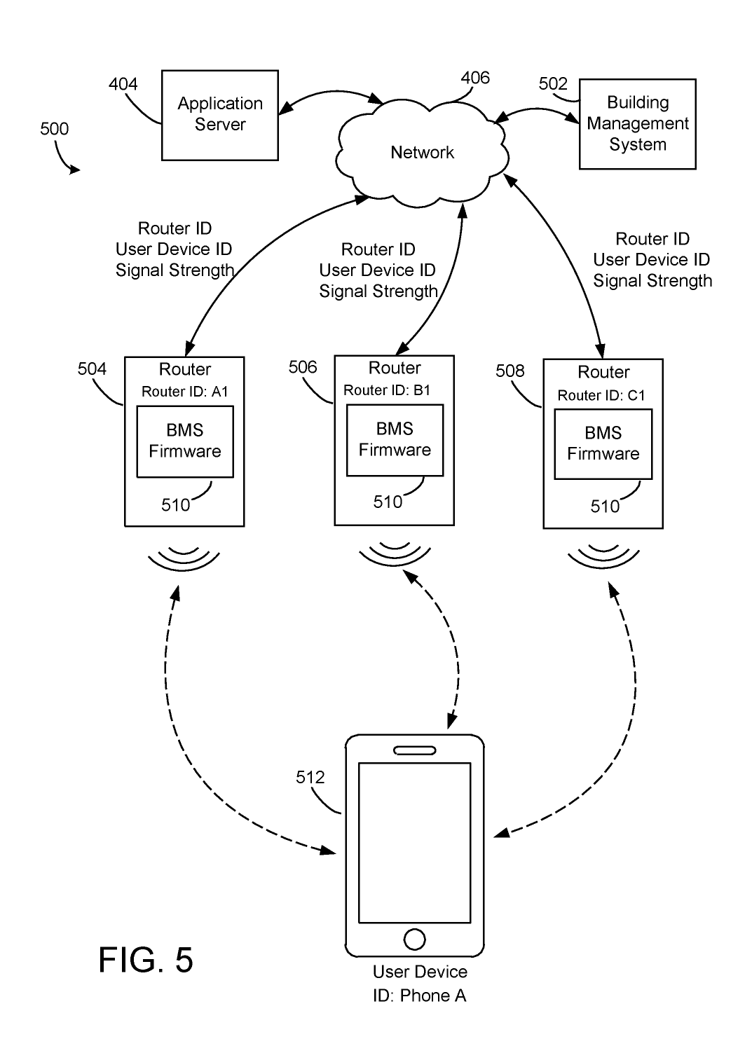

Referring now to FIG. 5, a block diagram of another occupancy tracking system 500 is shown, according to an exemplary embodiment. System 500 is shown to include many of the same components as system 400. For example, system 500 is shown to include application server 404 and network 406, which may be the same or similar as previously described with reference to FIG. 4. In system 500, application server 404 is connected to building management system 502 and routers 504-508 through network 406. Routers 504-508 may be the same and/or similar to routers 408-412 as described with reference to FIG. 4. Building management system 502 may control the building space as described with reference to FIGS. 1-3. Building management system 502 may be the same and/or similar to the building management system 402 as described with reference to FIG. 4. Building management system 502 may be further configured to determine the approximate location of user device 512 based on signal strength information received from one or more routers 504-508. In some embodiments, building management system 502 determines the location of user device 512 based on a router ID, a user device ID, and a signal strength between each of the routers 504-508 and user device 512. In FIG. 5, building management system 502 receives the router ID, user device ID, and signal strength directly from routers 504-508.

System 500 may have advantages to system 400 of FIG. 4. In FIG. 4, user device 414 calculates its own position relative to routers 408-412. This may require a customized application to run on user device 414 or may require user device 414 to be preconfigured to determine its own location. A user device communicating to routers 408-412 that is not running the customized application or has not been preconfigured will not determine its location and the occupancy of a user associated with the non-configured user device may go undetected. System 500 allows the building management system 502 to determine the location of a user device such as user device 512 by deploying customized firmware to the routers 504-508. Routers 504-508 together with building management system 502 are configured to determine the location of the user device 512 instead of user device 512 determining its own location. No custom configuration of user device 512 is necessary to determine the location of user device 512.

Routers 504-508 may be installed for the specific use of determining user occupancy or may be the existing routers in a wireless building network. In some embodiments, each router may have a unique ID. In FIG. 5, router 504 has the ID Al, router 506 has the ID Bl, and router 508 has the ID Cl. The routers may connect user device 512 to the Internet through network 406. In some embodiments, there are any number of routers located in the building space.

Routers 504-508 can be configured to emit, receive, sense, relay, or otherwise engage in unidirectional or bidirectional wireless communications. Routers 504-508 can use any type wireless technology or communications protocol. For example, in various embodiments, the wireless emitters/receivers can be Bluetooth low energy (BLE) emitters, near field communications (NFC) devices, Wi-Fi transceivers, RFID devices, ultrawide band (UWB) devices, infrared emitters/sensors, visible light communications (VLC) devices, ultrasound devices, cellular transceivers, iBeacons, or any other type of hardware configured to facilitate wireless data communications. In some embodiments, routers 504-508 are integrated with various devices within the building (e.g., thermostats, lighting sensors, zone controllers).

Routers 504-508 can broadcast a wireless signal. The wireless signal broadcast by routers 504-508 can include an identifier associated with routers 504-508. In some embodiments, the wireless signal broadcast by routers 504-508 includes multiple emitter identifiers (e.g., a UUID value, a major value, a minor value, etc.). Routers 504-508 can detect the wireless signals emitted by user device 512.

In some embodiments, each of routers 504-508 may be configured with BMS firmware 510. In some embodiments, BMS firmware 510 can be custom firmware deployed to routers 504-508 from building management system 502. In some embodiments, the custom firmware is deployed to routers 504-508 via the Internet (e.g., network 406). In some embodiments, routers 504-508 are custom built routers that are preconfigured with BMS firmware 510. The BMS firmware 510, may gather information specific to user device 512. User device 512 may be a smartphone, a tablet, a laptop computing device, a desktop computing device, a smart watch, a smart wrist band and/or any other such personal computing device. The BMS firmware 510 may be run by routers 504-508 and may be configured to determine an ID for user device 512 and a signal strength value for user device 512.

Routers 504-508 may each be configured to send their router ID, the user device ID, and the signal strength value associated with user device 512 to building management system 502 periodically. In some embodiments, there are any number of user devices connected to routers 504-508 and routers 504-508 send the user device ID and a signal strength for each of the user devices to the building management system 502. In some embodiments, the period of transmission to the building management system 502 may be defined by the BMS firmware 510. In some embodiments, the period of transmission may be defined by the building management system 502. In some embodiments, the period of transmission may be defined by the application server 404.

In FIG. 5 user device 512 communicates with routers 504-508. User device 512 may communicate to the routers via Wi-Fi, Zigbee, Bluetooth, and/or any other wireless communication protocol. User device 512 may communicate to routers 504-508 and routers 504-508 can determine a signal strength of the user device 512. In some embodiments received signal strength (RSSI) is determined by routers 504-508 based connections to user device 512. In some embodiments, routers 504-508 determine RSSI as a percentage, in mW, in dBm, and/or in any other unit or power ratio.

Building management system 502 may be configured to determine (e.g., estimate, triangulate, etc.) the location of user device 512 based on the location of each router and the determined RSSI value for each router to user device 512. In some embodiments, user device 512 is only connected to a single router. User device 512 may determine an approximate circular field around the single router that user device 512 may be located. In some embodiments, the circular field is simply an approximate radius such as a distance that user device 512 may be located away from the router. In some embodiments, the field is a range of radii. Each radii may be different and user device 512 may be located between the two radii.

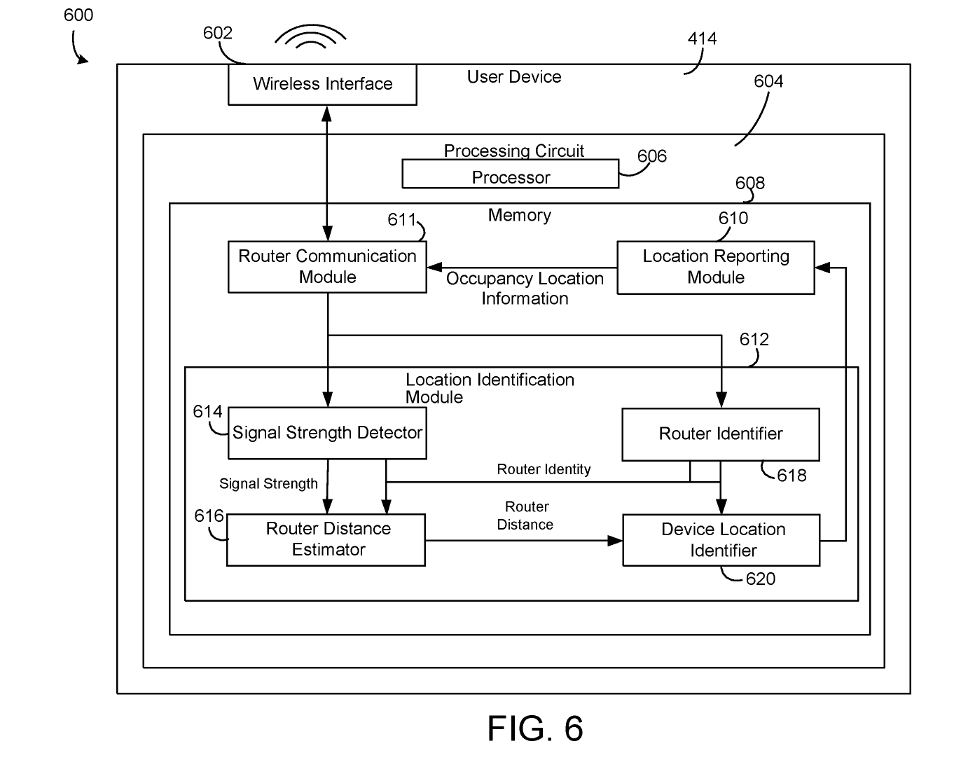

Referring now to FIG. 6, a block diagram illustrating user device 414 in greater detail is shown, according to an exemplary embodiment. User device 414 is shown to include a wireless interface 602 and a processing circuit 604. In some embodiments, wireless interface 602 can include (e.g., antennas, transmitters, receivers, transceivers, etc.) for conducting data communications with various systems, devices, or networks. As an example, the wireless interface 602 can include a WiFi transceiver for communicating via a wireless communications network (e.g., network 406).

Wireless interface 602 can be configured to communicate via local area networks (e.g., a building LAN), wide area networks (e.g., the Internet, a cellular network, etc.), and/or conduct direct communications (e.g., NFC, Bluetooth, etc.). In some embodiments, the wireless interface 602 includes an application gateway configured to receive input from applications running on client devices. For example, the wireless interface 602 can include one or more wireless transceivers (e.g., a WiFi transceiver, a Bluetooth transceiver, a NFC transceiver, a cellular transceiver, etc.) for communicating with mobile devices.

Processing circuit 604 is shown to include a processor 606 and memory 608. Processor 606 can be a general purpose or specific purpose processor, an application specific integrated circuit (ASIC), one or more field programmable gate arrays (FPGAs), a group of processing components, or other suitable processing components. Processor 606 may be configured to execute computer code or instructions stored in memory or received from other computer readable media (e.g., CDROM, network storage, a remote server, etc.).

Memory 608 can include one or more devices (e.g., memory units, memory devices, storage devices, etc.) for storing data and/or computer code for completing and/or facilitating the various processes described in the present disclosure. Memory 608 can include random access memory (RAM), read-only memory (ROM), hard drive storage, temporary storage, non-volatile memory, flash memory, optical memory, or any other suitable memory for storing software objects and/or computer instructions. Memory 608 can include database components, object code components, script components, or any other type of information structure for supporting the various activities and information structures described in the present disclosure. Memory 608 can be communicably connected to processor 606 via processing circuit 604 and can include computer code for executing (e.g., by processor 606) one or more processes described herein.

Memory 608 is shown to include location reporting module 610, router communication module 611, and a location identification module 612. Location reporting module 610 may be configured to report the location of user device 414 to building management system 402 and/or application server 404. In some embodiments, location reporting module 610 is configured to periodically send a location update to building management system 402 and/or application server 404. In some embodiments, the period of transmission to the building management system 402 and/or application server 404 may be defined by the building management system 402 and/or the application server 404. In some embodiments, the period of transmission may be a predetermined value stored in location reporting module 610. In some embodiments, a timer is used to determine an appropriate time to send the location. In some embodiments, the location is only sent to the building management system 402 and/or the application server 404 when the location changes for user device 414. In some embodiments, a change is defined as new location greater than a threshold. For example, the location may be stored in the form x, y, and z. A threshold value may be t. If a new location is determined which is x±t, y±t, and/or z±t, the new location may be sent to the building management system 402 and/or the application server 404.

Router communication module 611 may contain instructions to communicate with routers 408-412. In some embodiments, router communication module 611 contains instructions to communicate over a Wi-Fi network, a Zigbee network, and/or a Bluetooth network. Router communication module 611 may be able to facilitate communication a local area network or a wide area network (e.g., the Internet, a building WAN, etc.) and may facilitate communication with a variety of communications protocols (e.g., BACnet, IP, LON, etc.).

Location identification module 612 may be configured to determine the approximate location of user device 414 in the building space. Location identification module 612 may include a signal strength detector 614, a router distance estimator 616, a router identifier 618, and a device location identifier 620.

In some embodiments, signal strength detector 614 may be configured to determine the signal strength between wireless interface 602 and a router. In some embodiments, the router is at least one of routers 408-412. Signal strength detector 614 can be configured to determine an RSSI value for connections between wireless interface 602 and routers 408-412. In some embodiments, signal strength detector 614 can be configured to determine a received channel power indicator (RCPI) value. The signal strength detector 614 may be configured to determine a RSSI and/or RCPI value based on radio energy received from routers 408-412. In some embodiments, the signal strength detector 614 determines RSSI and/or RCPI as a percentage, a value in mW, a value in dBm, and/or a value in any other unit or power ratio.

In some embodiments, router distance estimator 616 performs a calculation to determine a distance to each router based on the signal strengths determined by signal strength detector 614. In some embodiments, router distance estimator 616 performs the estimation based on a signal strength received from signal strength detector 614 for a router identified by a router identity received from router identifier 618. In some embodiments, router distance estimator 616 is a free-space path loss equation such as:

$$FSPL = {( \frac{4 π df}{c} )}^{2}$$

FSPL may be based on the RSSI and/or RCPI values. The distance between user device 414 and the router in question may be d. The value f may be the signal frequency of the Wi-Fi signals. The value c may be the speed of light in a vacuum. Other such equations and forms of the above equation can be used to determine the distance between user device 414 and the router in question. In some embodiments, router distance estimator 616 may be configured to determine a distance between the router in question and the user device 414 based on techniques including angle of arrival (AoA) and time of flight (ToF).

In some embodiments, router distance estimator 616 is configured to use a fingerprint method in combination with trilateration to determine the location of the user device 414. In some embodiments, the fingerprint method may involve a training phase in which variances in signal strengths are measured at test locations. The variances in signal strength may be used to determine a signal strength fingerprint for anchor points. The anchor points may be used as reference points when determining the location of the user and/or when performing the trilateration calculation.

Router identifier 618 may be configured to identify each router within range of user device 414. For example, router identifier 618 may be configured to retrieve a router ID from each router within range. For example, router identifier 618 may identify router 408 as router B1 based on the router ID of router 408. Similarly, router identifier 618 may identify router 410 as Al and router 412 as Cl. In various embodiments, the router ID can be a MAC address, a SSID value, a hardware identifier, or other identifier uniquely identifying a particular router. Router identifier 618 may send router identities to device location identifier 620 so that device location identifier 620 can identify the location of the user device 414 with the determined router identities.

Device location identifier 620 may be configured to perform trilateration and/ortriangulation to determine the position of user device 414 based on a distance between the user device 414 and routers 408-412. In some embodiments, device location identifier 620 may determine the location of user device 414 for three dimensions or two dimensions. The trilateration process may use geometric shapes to perform the location calculation based on how many dimensions are being calculated. In some embodiments, the trilateration computation may use geometric shapes such as circles, spheres, and/or triangles. Device location identifier 620 may communicate the determined location to location reporting module 610.

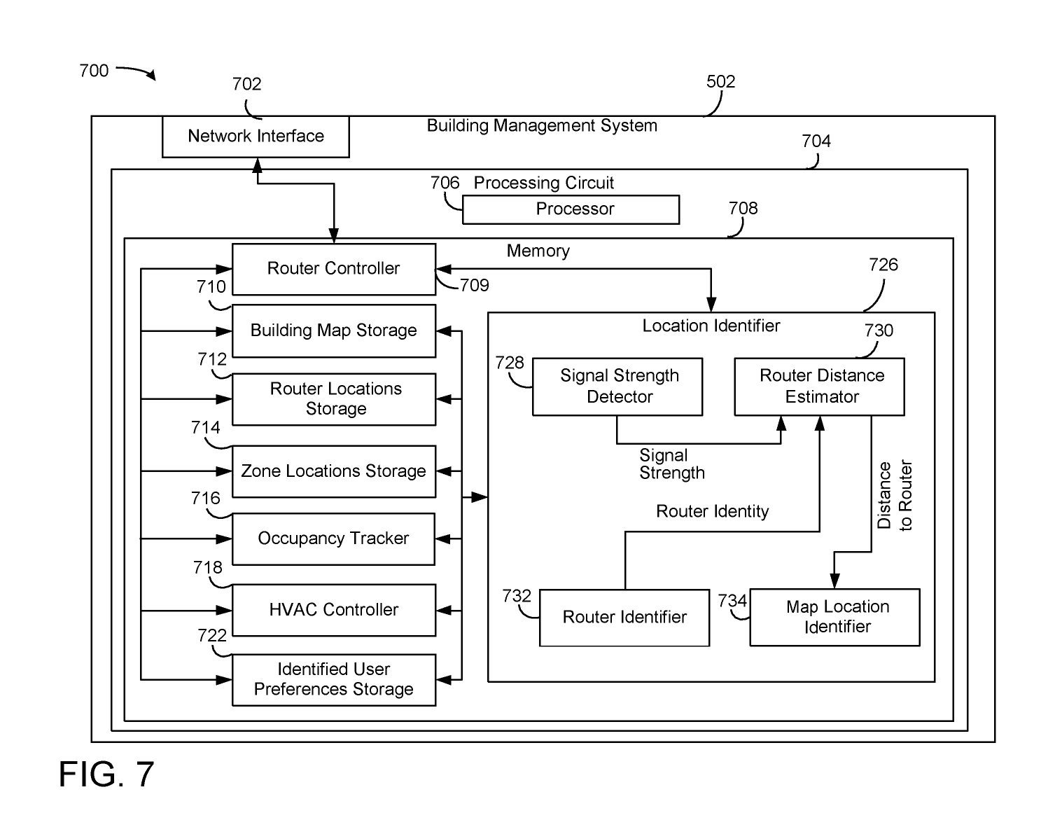

Referring now to FIG. 7, a block diagram of building management system 502 is shown, according to an exemplary embodiment. Building management system 502 is shown to include network interface 702 and processing circuit 704. Processing circuit 704 is shown to include processor 706 and memory 708. Processor 706 can be a general purpose or specific purpose processor, an application specific integrated circuit (ASIC), one or more field programmable gate arrays (FPGAs), a group of processing components, or other suitable processing components. Processor 706 is configured to execute computer code or instructions stored in memory or received from other computer readable media (e.g., CDROM, network storage, a remote server, etc.).

Memory 708 can include one or more devices (e.g., memory units, memory devices, storage devices, etc.) for storing data and/or computer code for completing and/or facilitating the various processes described in the present disclosure. Memory 708 can include random access memory (RAM), read-only memory (ROM), hard drive storage, temporary storage, non-volatile memory, flash memory, optical memory, or any other suitable memory for storing software objects and/or computer instructions. Memory 708 can include database components, object code components, script components, or any other type of information structure for supporting the various activities and information structures described in the present disclosure. Memory 708 can be communicably connected to the processor 706 via the processing circuit 704 and can include computer code for executing (e.g., by the processor 706) one or more processes described herein.

Memory 708 is shown to include router controller 709, building map storage 710, router locations storage 712, zone locations storage 714, occupancy tracker 716, HVAC controller 718, identified user preferences storage 722, and location identifier 726.

Router controller 709 may contain instructions to communicate with routers 504-508. In some embodiments, router controller 709 contains instructions to communicate over a Wi-Fi network, a Zigbee network, and/or a Bluetooth network via network interface 702. Router controller 709 may be able to facilitate communication a local area network or a wide area network (e.g., the Internet, a building WAN, etc) and may be configured to use a variety of communications protocols (e.g., BACnet, IP, LON, etc.). Building map storage 710, router locations storage 712, zone locations storage 714, occupancy tracker 716, HVAC controller 718, and identified user preferences storage 722 may all communicate to a network (e.g. network 406) and/or servers (e.g. application server 404) and/or devices (e.g. user device 414, user device 512) of the network through router controller 709.

Building map storage 710 may be configured to store a building map. In some embodiments, the building map may include multiple floors of a building, multiple facilities, and multiple campuses. Further, building map storage 710 may be configured to store the locations of routers, heat signatures of users, and/or building zones. Building map storage 710 may be configured to update the building map when commands are received via network interface 702. In some embodiments, the commands are received from application server 404. In some embodiments, commands to update the building map may be received from router locations storage 712, identified user preferences storage 722, and zone locations storage 714. These modules may send a command to update the building map whenever they determine new information and/or receive new information regarding the building map.

Router locations storage 712 may be configured to store the locations of multiple routers on multiple floors of a building. In some embodiments, application server 404 transmits the locations of the routers to router locations storage 712 via network 406 and network interface 702. Router locations storage 712 may be configured to update the building map stored in building map storage 710 whenever new information is received regarding the locations of the routers on at least one floor of the building.

Zone locations storage 714 may be configured to store the locations of multiple zones on at least one floor of a building. In some embodiments, application server 404 transmits the zones of the building space to Zone locations storage 714 via network 406 and network interface 702. Zone locations storage 714 may be configured to update the building map stored in building map storage 710 whenever new information is received regarding the zones on the floors of the building.

Occupancy tracker 716 may be configured to record occupancy in each zone by date and time. In some embodiments, occupancy tracker 716 communicates with the other modules of memory 708 and generates a record of occupancy based on date and time of the occupancy determined by the other modules of memory 708. HVAC controller 718 may use trended occupancy information from occupancy tracker 716 to anticipate times at which the building space will be occupied. In some embodiments, HVAC controller 718 may control the building space based on the immediate occupancy of the building space. For example, HVAC controller 718 may adjust heating and/or cooling throughout zones of a building based on the current occupancy in each zone of the building. The HVAC controller 718 may turn on building lights only in locations where occupancy is detected. In a further example, the HVAC controller 718 may preemptively adjust heating and/or cooling through the zones of the building based on expected occupancy. The HVAC controller 718 may identify that occupancy increases from zero occupants to 100 occupants between 4 A.M. and 7 A.M. on average every morning. HVAC controller 718 may preemptively turn on lighting to certain zones of the building and preemptively adjust the temperature of the building before the building is actually occupied. In some embodiments, HVAC controller 718 may cause information to be sent to an emergency response server. The information may identify the location of occupants of the zones, buildings, and campuses so that they can be reached by emergency responders.

Identified user preferences storage 722 may be configured to store information regarding the identity of multiple users and respective environmental and/or lighting preferences for each user. Identified user preferences storage 722 may receive notice that a user is present in a particular zone of a building from location identifier 726 and/or zone locations storage 714. HVAC controller 718 may retrieve the environmental and/or lighting preferences for the identified user and heat and/or condition the zone based on the preferences of the user and/or turn lights on or off in the zone by sending signals and/or commands to HVAC controller 718.

Location identifier 726 may be configured to determine the approximate location of user device 512 in the building space. Location identifier 726 may include a signal strength detector 728, a router distance estimator 730, a router identifier 732, and a map location identifier 734. Location identifier 726 is shown to communicate with blocks: router controller 709, building map storage 710, router locations storage 712, zone locations storage 714, occupancy tracker 716, HVAC controller 718, and identified user preferences storage 722. Location identifier 726 may communicate with these blocks to acquire all necessary data for determining the location the user device and/or to update each block with the determined location of the user.

In some embodiments, signal strength detector 728 may be configured to receive the signal strengths between user device 512 from at least one of routers 504-508 via network interface 702 and network 406. Signal strength detector 728 can be configured to receive an RSSI value for connections between user device 512 and routers 504-508. In some embodiments, signal strength detector 728 can be configured to receive a channel power indicator (RCPI) value. The signal strength detector 728 may be configured to receive a RSSI and/or RCPI value based on radio energy determined by routers 504-508. In some embodiments, the signal strength detector 728 receives RSSI and/or RCPI as a percentage, a value in mW, a value in dBm, and/or a value in any other unit or power ratio from the routers 504-508.

In some embodiments, router distance estimator 730 performs a calculation to determine a distance between routers 504-508 and user device 512 based on the signal strengths stored in signal strength detector 728 and a router identity stored in router 732. In some embodiments, router distance estimator 730 is a free-space path loss equation such as:

$$FSPL = {( \frac{4 π df}{c} )}^{2}$$

FSPL may be based on the RSSI and/or RCPI values stored in signal strength detector 728. The distance user device 512 is from the router in question may bed. The value f may be the signal frequency of the Wi-Fi signals. The value c may be the speed of light in a vacuum. Other such equations and forms of the above equation can be used to determine the distance between user device 512 and the router in question. In some embodiments, router distance estimator 730 may be configured to determine a distance between the router in question and the user device 512 based on techniques including angle of arrival (AoA) and time of flight (ToF).

Router identifier 732 may be configured to identify each router within range of user device 512. For example, router identifier may be configured to retrieve a router ID from each router within range. For example, router identifier 732 may identify router 504 as router A1 based on the router ID of router 504. Similarly, router identifier 732 may identify router 506 as B1 and router 508 as C1. In various embodiments, the router ID can be a MAC address, a SSID value, a hardware identifier, or other identifier uniquely identifying a particular router. Router identifier 732 may send router identities to router distance estimator 730 so that router distance estimator 730 can identify the location of the user device 414 with the determined router identities.

Map location identifier 734 may be configured perform trilateration and/or triangulation to determine the position of user device 512 based on a distance between the user device 512 and routers 504-508. In some embodiments, map location identifier 734 may determine the location of user device 512 for three dimensions or two dimensions. The trilateration process may use geometric shapes to perform the location calculation based on how many dimensions are being calculated. In some embodiments, the trilateration computation may use geometric shapes such as circles, spheres, and/or triangles. In some embodiments, once map location identifier module determines the location of user device 512, map location identifier module may update building map storage 710 accordingly.

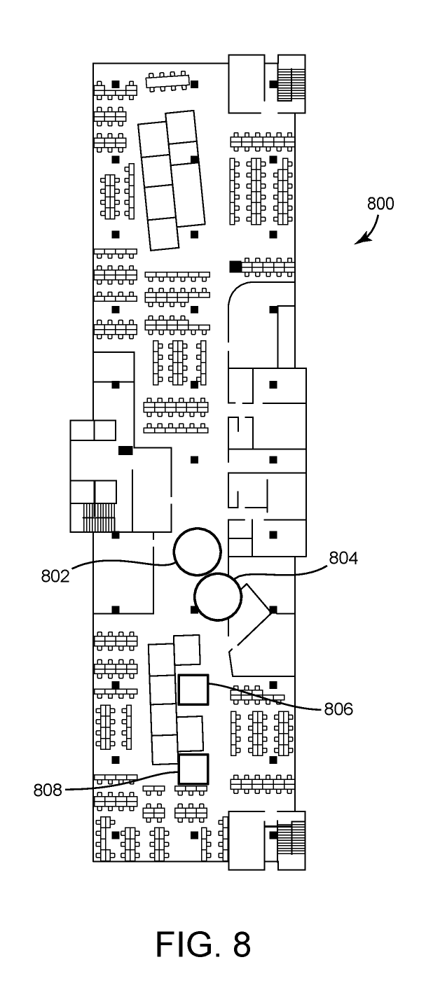

Referring now to FIG. 8, a building floor map 800 showing the locations of user heat signatures and routers is shown, according to an exemplary embodiment. FIG. 8 is shown to include heat signatures 802 and 804. FIG. 8 is also shown to include routers 806 and 808. Floor map 800 may be displayed in a web based application. In some embodiments, the web based application may be hosted by application server 404. In some embodiments, application server 404 receives the locations of users (e.g. heat signatures) from building management system 402 or building management system 502. In some embodiments application server 404 receives the locations of users (e.g. heat signatures) from user device 414 via network 406. In some embodiments, application server 404 may populate the locations of the users (e.g. heat signatures) on the map 800.

Routers 806 and 808 are displayed on floor map 800. In some embodiments, the web based application allows a user to change and select the locations for the routers based on the actual locations of the routers in the building. This allows an installation technician to tell the web based application where the positions of the currently installed routers are in the building rather than installing new routers.

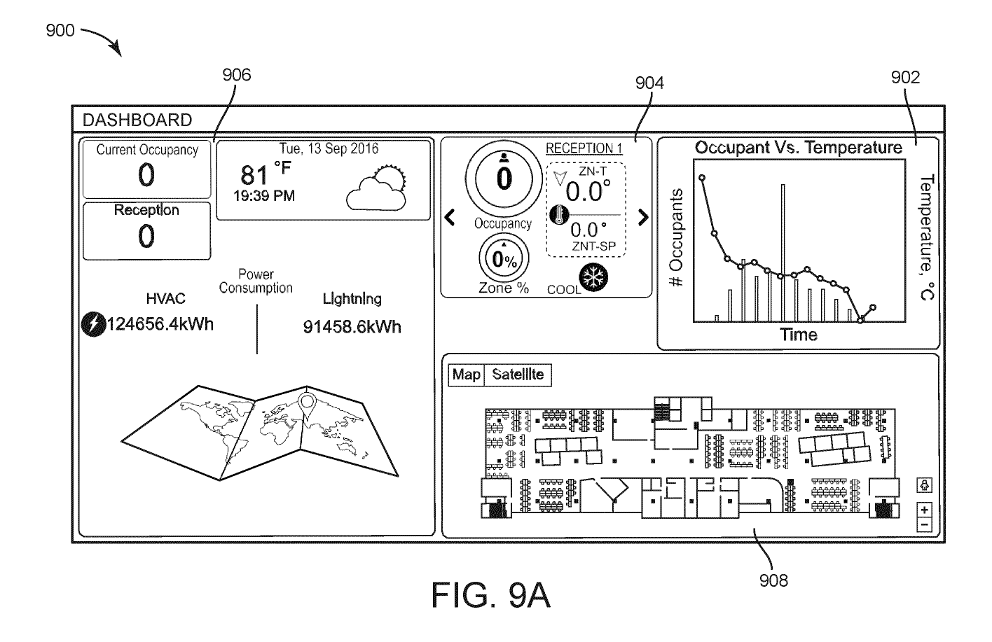

Referring now to FIGS. 9A and 9B, a dashboard 900 displaying occupancy of a building (e.g., building 10) is shown. Dashboard 900 may be displayed in a web based application. In some embodiments, the web based application may be hosted by an application server such as applications server 404. In some embodiments, the application server receives the locations of users (e.g. heat signatures) from building management system 402 or building management system 502. Dashboard 900 may display an occupant vs. temperature trending graph 902, a zone by zone report 904, an overview of the building 906, and an occupancy building map 908 (e.g. building floor map 800). In some embodiments, zone report 904 may display information such as number of occupants within the zone, percentage of occupants in the zone, and setpoint temperatures for the zone. In some embodiments, overview of the building 906 may display information such as current occupancy of the building, current weather reports, and an efficiency of the BMS.

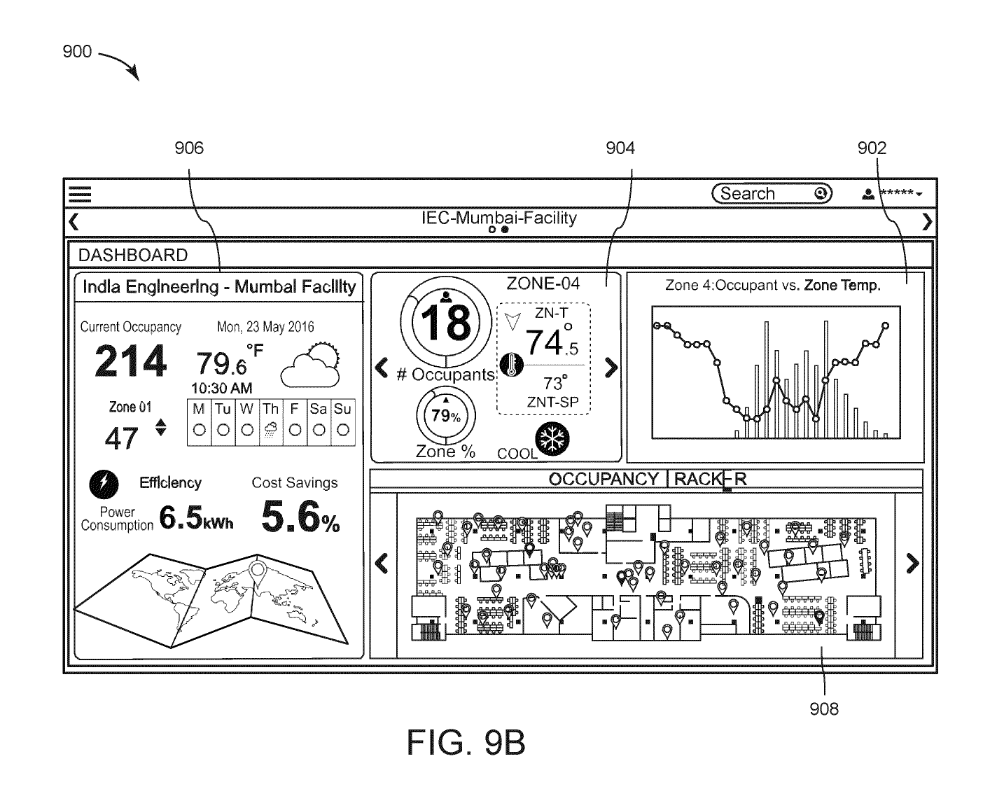

Referring now to FIG. 10, a flow diagram of a process 1000 for determining and visualizing the occupancy of a building is shown, according to an exemplary embodiment. In some embodiments, process 1000 is performed by an application server (e.g., application server 404), as described with reference to FIG. 4. For example, the application server may be a web based server. In some embodiments, the application server is a component of a building management system (e.g., the BMS 402 and/or the BMS 502). When a user logs onto the web based server, the user may be able to upload a floor plan for the building (step 1002). The applications server may be configured to automatically determine building dimensions, walls, rooms, zones, etc. based on the uploaded floor plan (step 1004). The application server may allow a user to define each zone of the building (step 1006). The application server may be configured to communicate with a BMS and/or individual user mobile devices to determine the occupancy through each zone of a building (step 1008). The application server may record and trend the occupancy data based on time, date, and building zone. (step 1010). The application server may update a heat map (step 1012) based on the determined occupancy in step 1008. The application server may communicate occupancy information to a BMS so that the BMS can perform building controls based on the determined occupancy (step 1014).

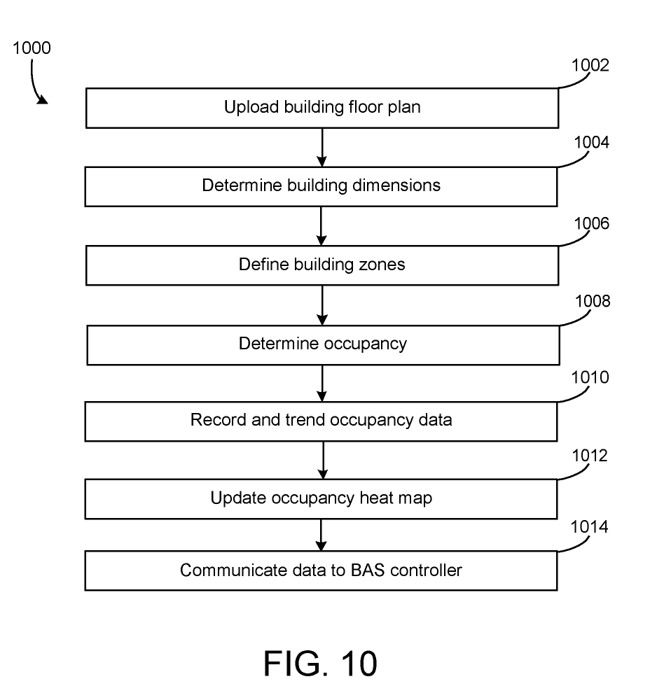

Referring now to FIG. 11, a flow diagram of a process 1100 for determining the location of a user device and communicating the location to a server is shown, according to an exemplary embodiment. In step 1102, a user device is configured to determine signal strengths for connections between the user device and one or more routers and an identify of each router. The user device may use the signal strengths (e.g., RSSI values) and the identify of each router (e.g., router IDs) to perform determine (e.g., perform triangulation and/or trilateration) an approximate location in a building (step 1104). This determination may be performed as described in FIG. 6 in router distance estimator 616. Once the location of the user device is identified, the user device may transmit the determined location to a server (step 1106). The server may receive multiple user device locations from multiple user devices and may combine the information to determine occupancy across multiple zones of a building (step 1108). Based on the determined occupancy, the server may determine heat signature locations to place on a map of the building (step 1110).

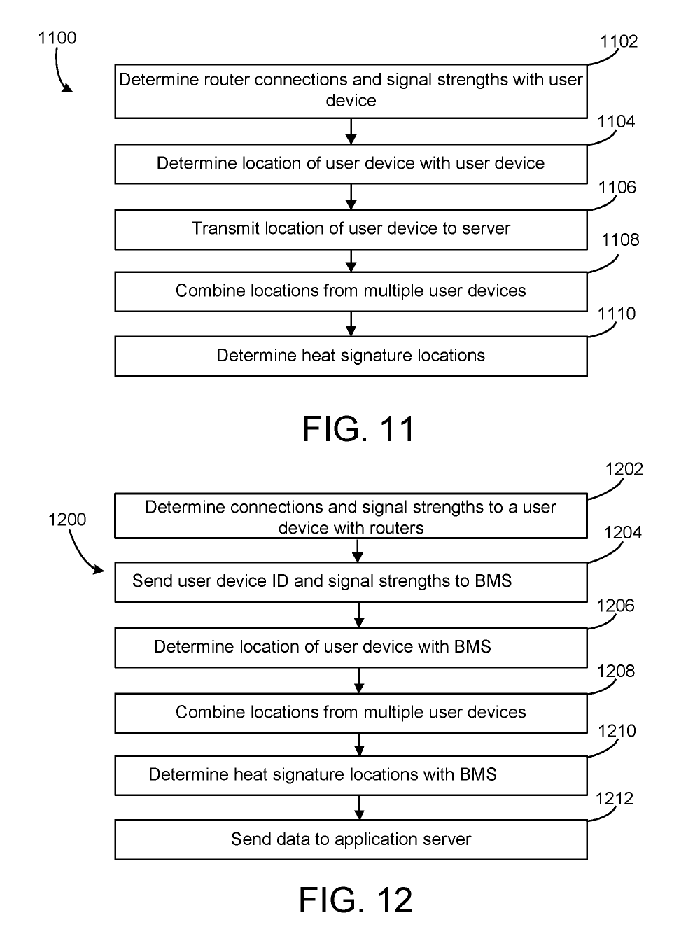

Referring now to FIG. 12, a flow diagram of a process 1200 for determining a user location in a building is shown, according to an exemplary embodiment. In step 1202, multiple routers may determine a signal strength to a user device. In some embodiments, the signal strength is an RS SI value. Each router may record the RS SI value to the user device and a user ID and send this information to a BMS (step 1204). The BMS may use the signal strength and user ID to perform location determination (e.g., triangulation and/or trilateration) and identify the location of the user (step 1206) such as described in FIG. 7 in router distance estimator 730. The BMS may determine multiple locations for multiple user devices and may combine these locations to determine the total occupancy of the building and the zone by zone occupancy (step 1208). In some embodiments, the BMS may determine locations for users across multiple buildings and/or multiple campuses. The BMS may determine heat signature locations for the building map and may identify an approximate heat generation in each zone of the building (step 1210). Finally, the BMS may send the occupancy information to an application server for web based viewing of the building occupancy (step 1212).

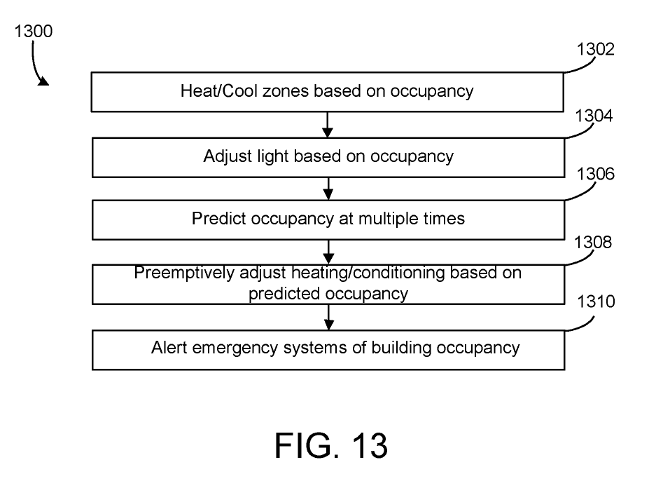

Referring now to FIG. 13, a flow diagram of a process 1300 for controlling a building based on determined occupancy is shown, according to an exemplary embodiment. In step 1302, each zone of a building may be conditioned based on occupancy. In some embodiments, a BMS may heat and/or cool zones of a building based on occupancy and may reduce overall energy costs by not heating and/or cooling zones that are not occupied. In some embodiments, the BMS may heat and/or cool zones of the building based on environmental setpoints entered by the user through a web-based interface. The BMS may be configured to only turn on lights in zones in which there are occupants (step 1304). Further, occupancy may be predicted based on at multiple times based on past data logging (step 1306). The BMS may preemptively adjust heating and/or cooling through the zones of the building based on expected occupancy (step 1308). The BMS may identify that occupancy increases from zero occupants to 100 occupants between 4 A.M. and 7 A.M. on average every morning.

The BMS may preemptively adjust the temperature of the building before the building is actually occupied. In some embodiments, the lighting of a building may be adjusted based on expected occupancy. For example, a BMS may turn on lighting to a specific zone at 4 A.M. if occupancy is determine in that zone. Also, the BMS may turn off the lighting to a specific zone at 6 P.M. on a Friday if the zones are determined to be empty. In process 1310, an emergency system may be alerted based on the occupancy of zones, buildings, and campuses which may be experiencing an emergency. In some embodiments, information may be sent to an emergency response server. The information may identify the location of occupants of the zones, buildings, and campuses so that they can be reached by emergency responders.

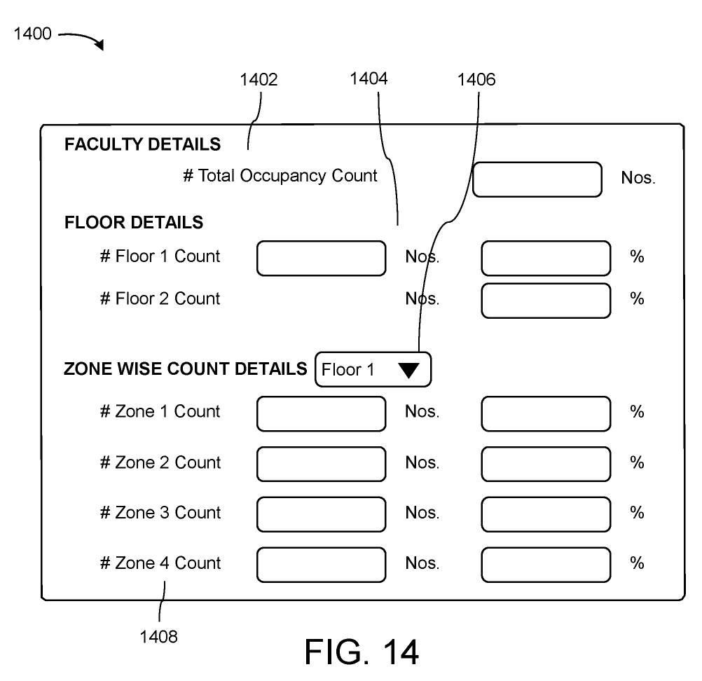

Referring now to FIGS. 14-18, various interactive screens are shown, according to exemplary embodiments. These screens may be generated by and displayed in a web based application. The interfaces can be displayed via a user interface of the user device 414. In some embodiments, the web based application may be hosted by application server 404. In some embodiments, application server 404 receives the locations of users (e.g. heat signatures) from building management system 402 or building management system 502. In some embodiments, application server 404 receives the locations of users (e.g. heat signatures) from user device 414 via network 406.

Referring now to FIG. 14, a diagram of a live value screen 1400 displaying a live occupancy density is shown, according to an exemplary embodiment. Live value screen 1400 may be displayed in a web based application (e.g., a web interface hosted by application server 404). Live value screen 1400 automatically updates and displays a total occupancy count 1402 based on the locations of users (e.g. heat signatures) received by the application server 404 from building management system 402 or building management system 502. In some embodiments, live value screen 1400 displays floor occupancy count 1404, such as the number of occupants on each floor and the percentage of occupants on each floor based on the total building occupancy. Live value screen 1400 is also shown to include zone occupancy count 1408 based on floor selection input 1406, in which a user can select which floor occupancy breakdown to view. In some embodiments, zone occupancy count 1408 displays information such as the number of occupants in each zone and the percentage of occupants in each zone based on the total floor occupancy. In some embodiment, zone occupancy count 1408 may display the percentage of occupants in each zone based on the total building occupancy.

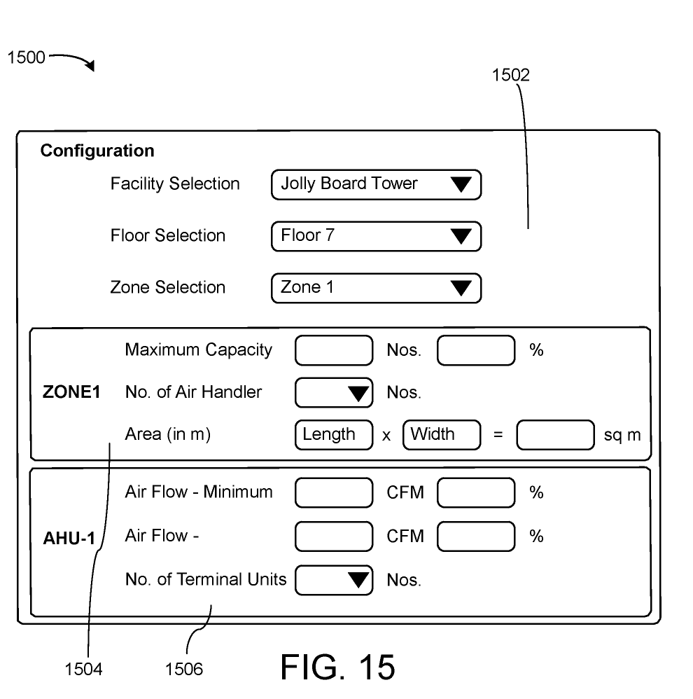

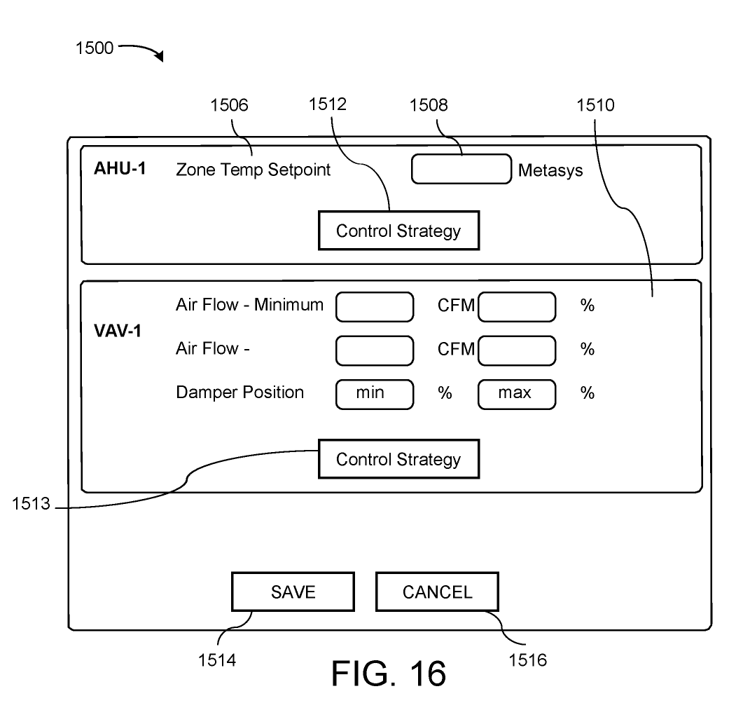

Referring now to FIGS. 15 and 16, a diagram of a configuration screen 1500 displaying facility configuration information is shown, according to an exemplary embodiment. Configuration screen 1500 may be generated by and displayed in a web based application (e.g., a web interface hosted by application server 404). Configuration screen 1500 allows a user select a location in order to tell the web based application how to configure the building management system for that specific location.

Referring now to FIG. 15, configuration screen 1500 is shown including input location selection 1502, according to an exemplary embodiment. In some embodiments, location selection 1502 may include facility selection, floor selection, and zone selection. Zone input section 1504 allows a user to enter specific information in relation to the selected location from location selection 1502. In some embodiments, a user may enter the maximum capacity of the location, the number of AHUs servicing the location, and dimensions of the location. In some embodiments, the number of AHUs servicing the location may be selected from a drop-down list. In one embodiment, the maximum number of AHU within a zone is 5. Zone input section 1504 may automatically display a calculated percentage of occupants in the location based on the maximum capacity input by the user and the current number of occupants in the location.

Zone input section 1504 may automatically display a calculated area of the location based on the input dimensions. Based on the number of AHU selected, configuration screen 1500 will update and display the same number of AHU input sections. In the embodiment shown, there is a single AHU input section 1506 or multiple AHU input sections 1506 when multiple AHUs are associated with a zone. In some embodiments, AHU input section 1506 allows a user to enter settings for the selected AHU, such as minimum air flow, maximum air flow, and number of terminal units. AHU input section 1506 may automatically display a calculated percentage of air flow, based on the input air flows and the current airflow settings.

Referring now to FIG. 16, AHU input section 1506 further includes temperature setpoint input 1508, which allows a user to enter a location specific temperature setpoint. Configuration screen 1500 also includes VAV input section 1510. In some embodiments, a user may enter information relating to the VAV such as minimum air flow and maximum air flow. VAV input section 1510 may automatically display a calculated percentage of air flow for the VAV based on the input minimum and maximum. Configuration screen 1500 further includes control strategy selector 1512 and 1513, which allows a user to navigate to a control strategy screen upon selection. Control strategy button 1512 may navigate to a control strategy screen for AHU-1 while control strategy button 1513 may navigate to a control strategy screen for VAV-1. In some embodiments, save selector 1514 may update all configuration settings as input by the user on the configuration screen 1500. The web based application may then interact with application server 404 to update settings of building management system 402 or building management system 502. In some embodiments, cancel selector 1516 will clear the inputs of the configuration screen 1500.

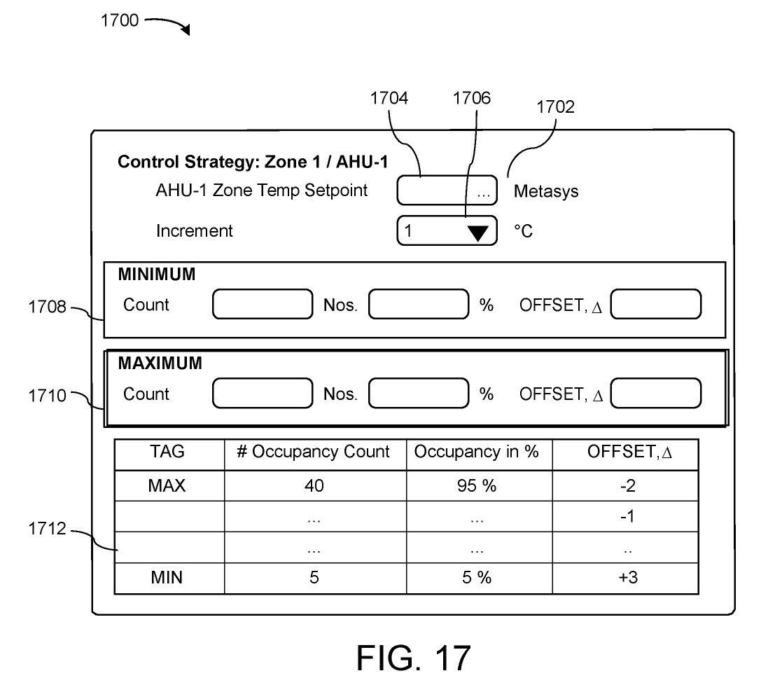

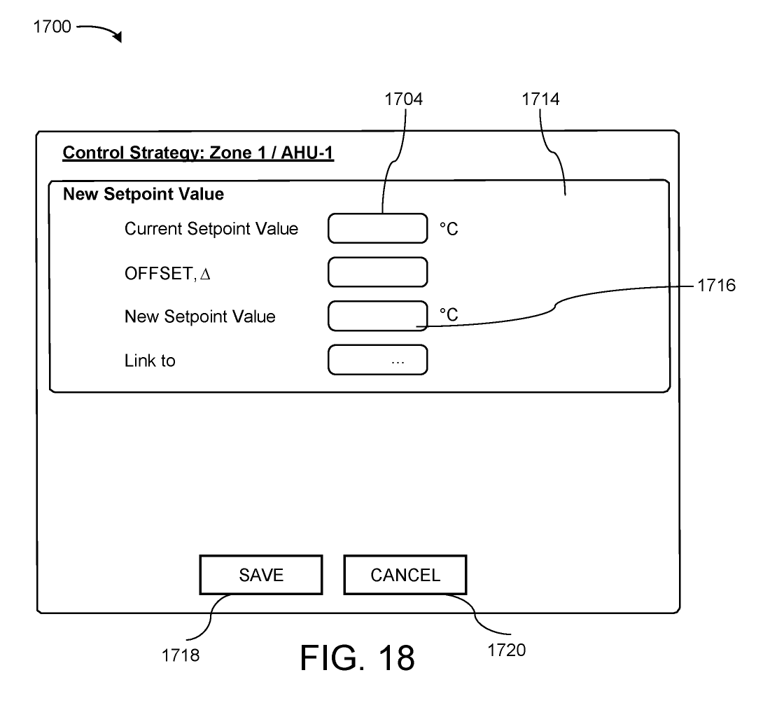

Referring now to FIGS. 17 and 18, a control strategy screen 1700 is shown, according to exemplary embodiments. Control strategy screen 1700 may be displayed in a web based application (e.g., a web interface hosted by application server 404). In one embodiment, a user may navigate to control strategy screen 1700 by selection of control strategy selector 1512 on configuration screen 1500. In some embodiments, control strategy screen 1700 allows a user to input settings for a single AHU. AHU input section 1702 is shown to include AHU temperature setpoint 1704 and increment selector 1706. In some embodiments, AHU temperature setpoint 1704 is the temperature setpoint input on configuration screen 1500. In other embodiments, a user may select from a range of values within the AHU temperature setpoint 1704. Increment selector 1706 may be a drop down list that allows a user to select a temperature increment value. In some embodiments, increment selector 1706 may include a range of values from one to five.

Control strategy screen includes minimum input 1708 and maximum input 1710. In some embodiments, minimum input 1708 allows a user to select a minimum occupancy count, a percentage of total occupancy at that minimum occupancy count, and an offset value from the temperature setpoint at that minimum occupancy count. In some embodiments, maximum input 1710 allows a user to select a maximum occupancy count, a percentage of total occupancy at that maximum occupancy count, and an offset value from the temperature setpoint at that maximum occupancy count. Control strategy screen 1700 automatically displays a calculated occupancy table 1712 based on AHU temperature setpoint 1704, increment selector 1706, minimum input 1708, and maximum input 1710. In some embodiments, occupancy table 1712 may display offsets in the setpoint temperature for a range of occupancy counts, from the minimum occupancy to the maximum occupancy of the zone.

Referring now to FIG. 18, control strategy screen 1700 further includes new setpoint section 1714. In some embodiments, AHU temperature setpoint 1704 is displayed, along with an offset value. New setpoint input 1706 allows a user to input an updated temperature setpoint. In some embodiments, new setpoint input 1706 may correspond to a previously input setpoint from configuration screen 1500. In some embodiments, strategy screen 1700 further includes save selector 1718, which may update all configuration settings as input by the user on the control strategy screen 1700. The web based application may then interact with application server 404 to update settings of building management system 402 or building management system 502. In some embodiments, cancel selector 1720 will clear the inputs of the control strategy screen 1720.

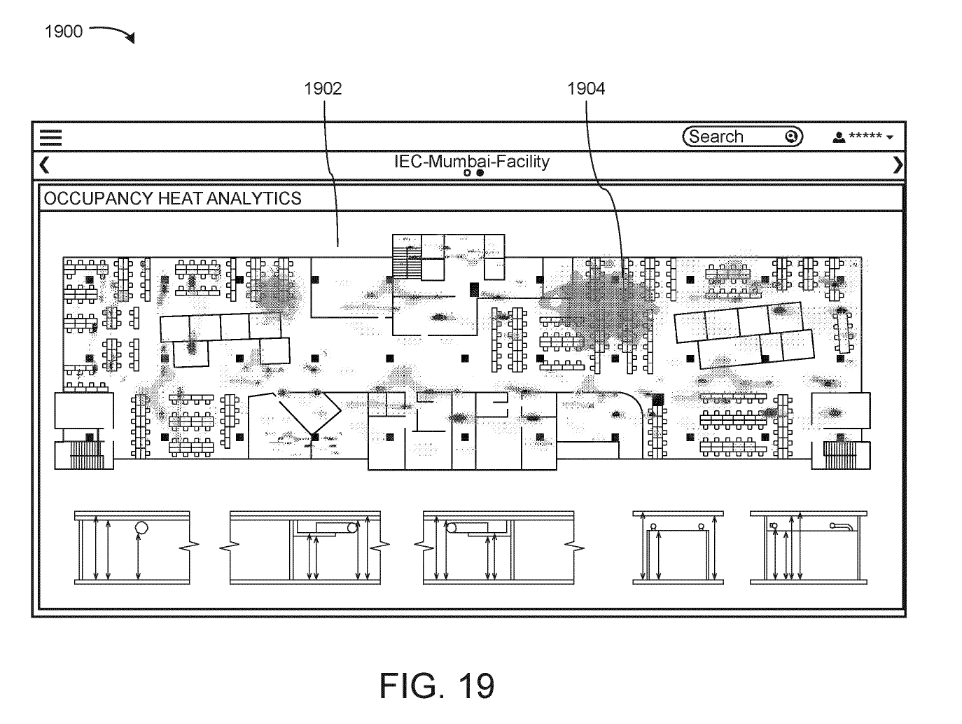

Referring now to FIG. 19, a dashboard 1900 displaying occupancy heat analytics is shown, according to an exemplary embodiment. Dashboard 1900 includes building floor map 1902. Dashboard 1900 may be displayed in a web based application (e.g., a web interface hosted by application server 404). In some embodiments, the web based application may be hosted by application server 404. In some embodiments, application server 404 receives the location of users (e.g. heat signatures) from building management system 402 or building management system 502. In some embodiments, application server 404 receives the location of users (e.g. heat signatures) from user device 414 via network 406. In some embodiments, application server 404 may populate the locations of the users (e.g. heat signatures) on the map 1902. High heat area 1904 is displayed on floor map 1902. In some embodiments, high heat area 1904 may correspond to a location with a high user occupancy density, based on the user locations received by the application server 404. In other embodiments, high heat area 1904 may correspond to a location with a low user occupancy, based on the user locations received by the application server 404. In this embodiment, high heat area 1904 represents a location where a higher offset temperature setpoint setting may be used to compensate for the low user occupancy.

User input values from the configuration screen 1500 and control strategy screen 1700 may be used to update settings of building management system 412 or building management system 502. Application server 404 may communicate the input values from the web based application to the building management system 402 via network 406. In some embodiments, BMS controller 366 sends the updated settings to AHU controller 330, which in turn operates AHU 302 based on the input and calculated settings from the web based application. Building management system 402 or building management system 502 operates to heat or cool the building based on the tracked user occupancies and the input settings.

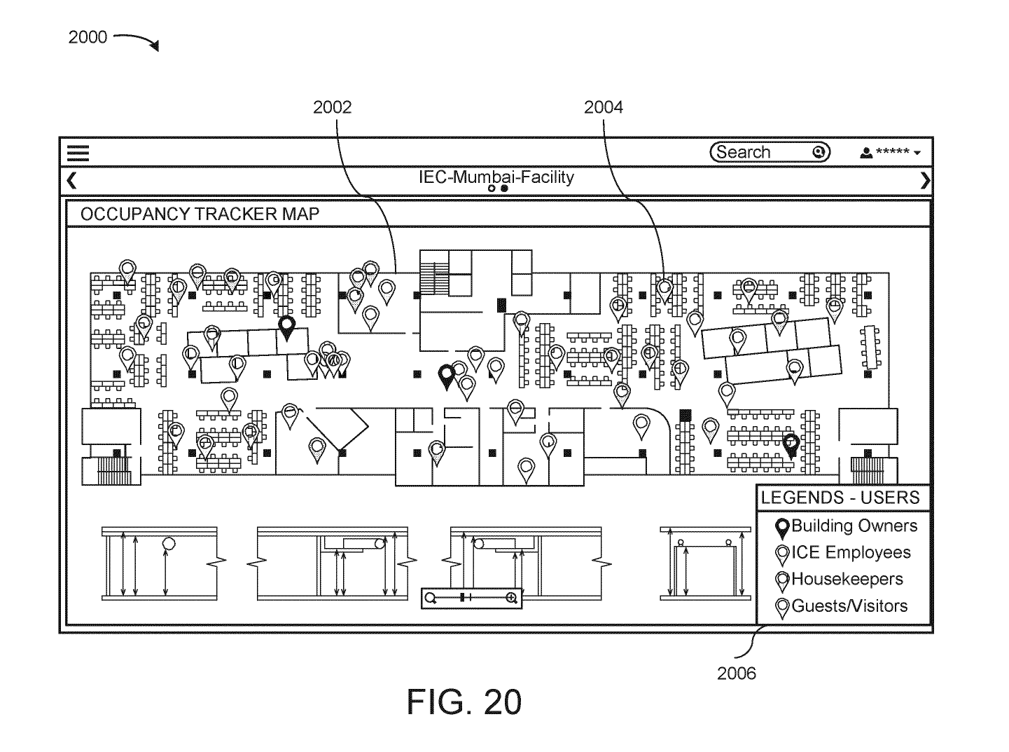

Referring now to FIG. 20, a dashboard 2000 displaying an occupancy tracker is shown, according to an exemplary embodiment. Dashboard 2000 includes building floor map 2002. Dashboard 2000 may be displayed in a web based application. In some embodiments, the web based application may be hosted by application server 404. In some embodiments, application server 404 receives the location of users (e.g. heat signatures) from building management system 402 or building management system 502. In some embodiments, application server 404 receives the location of users (e.g. heat signatures) from user device 414 via network 406. In some embodiments, application server 404 may populate the locations of the users (e.g. heat signatures) on building floor map 2002. Building floor map 2002 displays user location pins 2004, to indicate the location of a user. User location pins 2004 may be specific and distinct for each type of user. Type of user may correspond to the unique ID of each user device 414 or user device 512 sent to application server 404. Legend 2006 allows for the distinction between user location pins 2004 based on the type of user. In some embodiments, types of users may include building owners, employees, housekeepers, and guests.

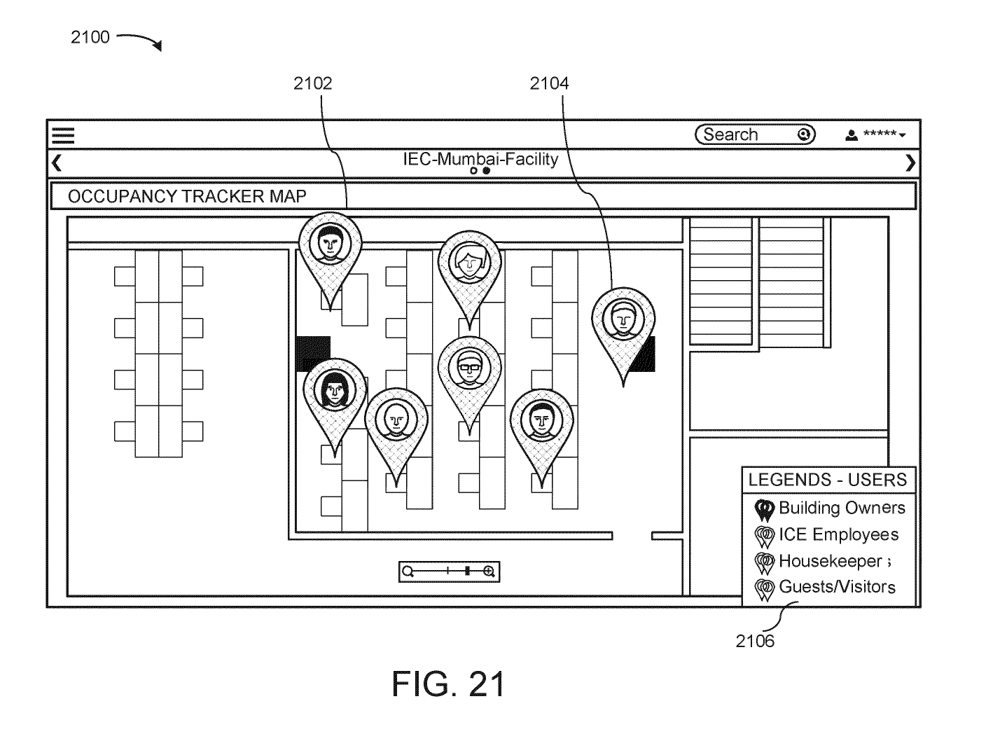

Referring now to FIG. 21, a dashboard 2100 displaying an occupancy tracker is shown, according to an exemplary embodiment. Dashboard 2100 includes building zone map 2102. Dashboard 2100 may be displayed in a web based application. In some embodiments, the web based application may be hosted by application server 404. In some embodiments, application server 404 receives the location of users (e.g. heat signatures) from building management system 402 or building management system 502. In some embodiments, application server 404 receives the location of users (e.g. heat signatures) from user device 414 via network 406. In some embodiments, application server 404 may populate the locations of the users (e.g. heat signatures) on zone map 2102. Building zone map 2102 displays user location pins 2104, to indicate the location of a user. User location pins 2104 may be specific and distinct for each type of user. Type of user may correspond to the unique ID of each user device 414 sent to application server 404. In the embodiment shown, an image of the user is shown on each user location pin 2104. Legend 2106 allows for the distinction between user location pins 2104 based on the type of user. In some embodiments, types of users may include building owners, employees, housekeepers, and guests.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. An occupancy tracking system for tracking occupancy within a building, the occupancy tracking system configured to:
determine one or more wireless signal strengths for one or more wireless connections between one or more wireless routers and one or more user devices located within the building;
determine, based on the one or more wireless signal strengths, the locations of one or more occupants associated with the one or more user devices within the building and the number of the one or more occupants located within the building; and
control one or more pieces of building equipment based on the locations of the one or more occupants and the number of the one or more occupants.

2. The system of claim 1, wherein the occupancy tracking system further comprises the one or more wireless routers, wherein each of the one or more wireless routers are configured to:
determine the one or more wireless signal strengths for the one or more wireless connections between the wireless router and the one or more user devices; and
send the one or more wireless signal strengths to a building management system;
wherein the occupancy tracking system further comprises the building management system, wherein the building management system is configured to:
receive, from each of the one or more wireless routers, the one or more wireless signal strengths; and
determine, based on the received wireless signal strengths, the locations and the number of the one or more occupants within the building.

3. The system of claim 1, wherein the occupancy tracking system further comprises the one or more user devices, wherein each of the one or more user devices is configured to:
determine the one or more wireless signal strengths for the one or more wireless connections between the one or more wireless routers and the user device;
determine, based on the one or more wireless signal strengths, the location of the occupant associated with the user device within the building; and
send an indication of the location of the occupant to a building management system.

4. The system of claim 1, wherein the occupancy tracking system is configured to:
record the determined number of the one or more occupants within the building for a plurality of times;
predicted, based on the recorded number of the one or more occupants within the building for the plurality of times, a predicted number of occupants within the building for a particular time; and
control, based on the predicted number of occupants, the one or more pieces of building equipment at a time before the particular time to achieve a particular temperature in the building at the particular time.

5. The system of claim 1, wherein the occupancy tracking system is configured to generate an interface for display of one of the one or more user devices, the interface comprising:
an indication of the locations of the one or more occupants associated with the one or more user devices within the building; and
indications of identities of the one or more occupants associated with the one or more user devices, wherein the identities of the one or more occupants are based on identifiers of the one or more user devices.

6. The system of claim 5, wherein the indication of the locations of the one or more occupants comprises heat signatures that indicate the density of occupancy at particular locations within the building.

7. The system of claim 1, wherein the occupancy tracking system is configured to:
receive environmental configuration settings for one or more zones of the building from one of the one or more user devices; and
control the one or more pieces of building equipment based on the locations of the one or more occupants, the number of the one or more occupants, and the received environmental configuration settings.

8. The system of claim 7, wherein the environmental configuration settings comprise at least one of one or more heating configuration settings, one or more air conditioning configuration settings, one or more airflow configuration settings, and one or more lighting configuration settings.

9. The system of claim 7, wherein the configuration settings comprises zone configuration information for a zone of the building, the zone configuration information comprising a maximum occupancy level, a minimum occupancy level, a first temperature offset associated with the maximum occupancy level, and a second temperature offset associated with the minimum occupancy level;
wherein the occupancy tracking system is configured to:
determine a plurality of third temperature offsets based on the maximum occupancy level, the minimum occupancy level, the first temperature offset, and the second temperature offset, each third temperature offset associated with a potential number of occupants within the zone;
determine, based on the locations of the one or more user devices, an actual number of occupants within the zone of the building; and
control one or more of the one or more pieces of building equipment that are associated with the zone of the building based on the determined plurality of third temperature offsets and the actual number of occupants within the zone of the building.

10. An method for tracking occupancy within a building, the method comprising:
determining one or more wireless signal strengths for one or more wireless connections between one or more wireless routers and one or more user devices located within the building;
determining, based on the one or more wireless signal strengths, the locations of one or more occupants associated with the one or more user devices within the building and the number of the one or more occupants located within the building; and
controlling one or more pieces of building equipment based on the locations of the one or more occupants and the number of the one or more occupants.

11. The method of claim 10, the method further comprising, for each of the one or more wireless routers:
determining, by the wireless router, one or more wireless signal strengths for the one or more wireless connections between the wireless router and the one or more user devices; and
sending, by the wireless router, the one or more wireless signal strengths to a building management system; and
wherein the method further comprises:
receiving, by the building management system, the one or more wireless signal strengths from each of the one or more wireless routers; and
determining, by the building management system, based on the one or more received wireless signal strengths, the locations and the number of the one or more occupants within the building.

12. The method of claim 10, the method further comprising, for each of the one or more user devices:
determining the one or more wireless signal strengths for the one or more wireless connections between the one or more wireless routers and the user device;
determining, based on the one or more received wireless signal strengths, the location of the occupant associated with the user device within the building; and
sending an indication of the location of the occupant to a building management system.

13. The method of claim 10, the method further comprising:
recording the determined number of the one or more occupants within the building for a plurality of times;
predicting, based on the recorded number of occupants within the building for the plurality of times, a predicted number of occupants within the building for a particular time; and
controlling, based on the predicted number of occupants, the one or more pieces of building equipment at a time before the particular time to achieve a particular temperature in the building at the particular time.

14. The method of claim 10, the method further comprising causing a display of one of the one or more user devices to display an interface, the interface comprising:
an indication of the locations of the one or more occupants associated with the one or more user devices within the building; and
indications of identities of the one or more occupants associated with the one or more user devices, wherein the identities of the one or more occupants are based on identifiers of the one or more user devices.

15. The method of claim 14, wherein the indication of the locations of the one or more occupants comprises heat signatures that indicate the density of occupancy at particular locations within the building.

16. The method of claim 14, further comprising:
receiving environmental configuration settings for one or more zones of the building from the one of the one or more user devices; and
controlling the one or more pieces of building equipment based on the locations of the one or more occupants, the number of the one or more occupants, and the received environmental configuration settings.

17. The method of claim 16, wherein the environmental configuration settings comprise at least one of one or more heating configuration settings, one or more air conditioning configuration settings, one or more airflow configuration settings, and one or more lighting configuration settings.

18. The method of claim 16, wherein the configuration settings comprises zone configuration information for a zone of the building, the zone configuration information comprising a maximum occupancy level, a minimum occupancy level, a first temperature offset associated with the maximum occupancy level, and a second temperature offset associated with the minimum occupancy level;
wherein the method further comprises:
determining a plurality of third temperature offsets based on the maximum occupancy level, the minimum occupancy level, the first temperature offset, and the second temperature offset, each third temperature offset associated with a potential number of occupants within the zone;
determining, based on the locations of the one or more user devices, an actual number of occupants within the zone of the building; and
controlling one or more of the one or more pieces of building equipment that are associated with the zone of the building based on the determined third temperature offsets and the actual number of occupants within the zone of the building.

19. An occupancy tracking system for tracking occupancy within a building, the occupancy tracking system configured to:
determine one or more wireless signal strengths for one or more wireless connections between one or more wireless routers and one or more user devices located within the building;
determine, based on the one or more wireless signal strengths, the locations of one or more occupants associated with the user devices within the building and the number of the one or more occupants located within the building;
generate an interface for display, on a display of one of the one or more user devices, the interface comprising:
an indication of the locations of the one or more occupants associated with the one or more user devices within the building, wherein the indication of the locations of the one or more occupants comprises heat signatures that indicate the density of occupancy at particular locations within the building; and
indications of identities of the one or more occupants associated with the one or more user devices, wherein the identities of the one or more occupants are based on identifiers of the one or more user devices; and
control one or more pieces of building equipment based on the locations of the one or more occupants and the number of the one or more occupants.

20. The system of claim 19, wherein the occupancy tracking system is configured to:
receive environmental configuration settings for one or more zones of the building from the one of the one or more user devices; and
control the one or more pieces of building equipment based on the locations of the one or more occupants, the number of the one or more occupants, and the received environmental configuration settings.
